(19) United States
(12) Patent Application Publication
(10) Pub. No.: US 2013/0268122 A1
(43) Pub. Date: Oct. 10, 2013

(54) Systems, Methods, and Apparatus for Driving Servo Actuators

(71) Applicant: General Electric Company, Schenectady, NY (US)

(72) Inventors: Ravindra Mahavir Desai, Hyderabad (IN); Roy Anthony Carter, Salem, VA (US)

(21) Appl. No.: 13/908,499

(22) Filed: Jun. 3, 2013

Related U.S. Application Data
(63) Continuation-in-part of application No. 12/784,629, filed on May 21, 2010.

(51) Int. Cl. G05B 15/02

(52) U.S. Cl. CPC G05B 15/02
USPC 700/275

(57) ABSTRACT

Embodiments can include systems, methods, and apparatus for driving servo actuators. In one embodiment, a system may include a H-bridge circuit coupled to a winding circuit of the servo actuator, the H-bridge circuit including switching devices. The system can include a controller for providing a control pulse width modulation (PWM) signal to one of the switches. The PWM signal drives one of the switches to periodically establish a one-direction electric current path through the winding circuit. The system can include a feedback loop configured to measure a current flowing through the winding circuit and, based at least in part on the detection, generate a pulse frequency modulation (PFM) signal. The feedback loop can include a modulation switch that forces the operated switch of the H-bridge control circuit to periodically open based at least in part on the PFM signal controlling the current flowing through the winding circuit.

### RELATED APPLICATION

The present application is a continuation-in-part of and claims priority to U.S. Ser. No. 12/784,629, titled “Systems, Methods, and Apparatus for Providing High Efficiency Servo Actuator and Excitation Drivers,” filed on May 21, 2010, the contents of which are incorporated herein by reference.

### TECHNICAL FIELD

Embodiments of this disclosure relate generally to servo actuators and, more specifically, to systems, methods, and apparatus for driving servo actuators.

### BACKGROUND

Gas turbines utilize servomechanisms, sometimes shortened to servos, to control actuators associated with various components. The actuators may move fuel valves, speed ratio valves, compressor vanes, and other mechanical components to control air and fuel flow in the gas turbines. To control positions of the actuators, a certain amount of direct current (DC) may be passed through actuator coils, with the current amount being based at least in part on feedback from transducers coupled to the actuators. Various servo drives or servo controllers may be used to control the servomechanisms. Conventional servo controllers may provide drive current for the actuators using linear buffers or linear amplifiers, which typically require bulky heat sinks to dissipate excess heat produced by the drive electronics.

In many gas turbines, various valves and vanes may be controlled by hydraulic actuators. Positioning of the hydraulic actuators, valves, or vanes may be monitored and fed back to the servo controller using transducers such as resolvers, linear variable differential transformers (LVDTs), or linear variable differential reluctance (LVDR) devices. These devices are highly reliable in the harsh turbine environments, but they may require excitation alternating current (AC) for proper operation. The excitation AC is typically provided by an excitation drive circuit with a linear output amplifier, which may also require a bulky heat sink to dissipate the excess heat produced by the drive electronics.

When a turbine has a large number of valves, with each valve associated with actuators and LVDTs, the turbine's servo controller may become excessively bulky due to the number and size of the heat sinks Furthermore, when drive energy is converted to heat in the linear drive circuitry, the energy efficiency of the circuit is reduced, and the dissipated heat increases the overall temperature of the control panel.

### BRIEF SUMMARY OF THE DISCLOSURE

Some or all of the above needs may be addressed by certain embodiments of the disclosure. Certain embodiments of the disclosure may include systems, methods, and apparatus for driving servo actuators. In certain instances, embodiments of systems, methods, and apparatus can provide high efficiency servo actuator and excitation drivers.

According to one or more embodiments of the disclosure, a method is provided for driving a servo actuator. The method may include receiving a control PWM signal, operating a first switch based at least in part on the control PWM signal to establish an electric current path through a winding circuit of the servo actuator, generating a feedback signal based on at least one electric current flowing through the winding circuit, and controlling the electric current flowing through the winding circuit by providing a PFM of the first switch based on the feedback signal.

In one or more embodiments of the disclosure, the method may further include providing a H-bridge control circuit, which includes the first switch and the windings of the servo actuator. The H-bridge control circuit may further include a second switch so that the first switch and the second switch are opposite switches constituting a half bridge control circuit with the second switch closed. The providing of feedback may comprise measuring one or more voltages associated with the electric current flowing through the winding circuit. The generating of the feedback signal may comprise amplifying a difference in the one or more voltages associated with the electric current flowing through the winding circuit. The method may further include generating a modulation signal based on a comparison of the feedback signal and a reference signal. The method may further include operating a modulation switch based at least in part on the modulation signal. The operating of the modulation switch may provide the PFM of the first switch. The method may further include determining that the modulation signal exceeds the reference signal and, based on the determination, closing the modulation switch. The method may further include opening the first switch based at least in part on the closing of the modulation switch. The modulation switch and the first switch may provide a hysteretic control over the electric current flowing through the winding circuit.

According to another aspect of the disclosure, a system is provided for driving a servo actuator. The system may include a H-bridge control circuit configured to be coupled to a winding circuit of the servo actuator. The H-bridge control circuit may include a first switch. The system may further include a controller configured to provide a first PWM signal to the first switch. The first PWM signal may drive the first switch to periodically establish a first one-direction electric current path through the winding circuit. The system may further include a feedback loop configured to detect an electric current flowing through the winding circuit and, based at least in part on the detection, generate a PFM signal. The system may further include a first modulation switch configured to force the first switch to periodically open based at least in part on the PFM signal controlling the electric current flowing through the winding circuit.

In one or more embodiments of the disclosure, the servo actuator may include one or more of a servo actuator, a linear variable differential transformer, and a rotary variable differential transformer. The first switch and the first modulation switch may include one or more of metal-oxide-semiconductor field-effect transistors (MOSFETs). The H-bridge control circuit may further include a second switch. The first switch and the second switch may be opposite switches constituting a half bridge control circuit, which when enabled causes the electric current to flow through the winding circuit in one direction. The second switch may be permanently closed. The feedback loop may comprise at least one differential comparator configured to generate the PFM signal based on a comparison of the electric current flowing through the winding circuit to a reference value. The feedback loop may be further configured to delay closing times and opening times of the first switch to provide hysteretic control over the electric current flowing through the winding circuit. The H-bridge control circuit may further comprise a third switch and the controller and may be further configured to provide a second PWM signal to the third switch to periodically establish a second one-direction electric current path through the winding circuit with the second one-direction electric current path being opposite the first second one-direction electric current path. The system may further include a second modulation switch configured to force the third switch to periodically open based at least in part on the PFM signal of the feedback loop controlling the electric current flowing through the winding circuit.

Additional systems, methods, apparatuses, features, and aspects are realized through the techniques of various embodiments of the disclosure. Other embodiments and aspects of the disclosure are described in detail herein and are considered a part of the claimed disclosure. Other embodiments and aspects can be understood with reference to the description and the drawings.

### BRIEF DESCRIPTION OF THE DRAWINGS

Having thus described the disclosure in general terms, reference will now be made to the accompanying drawings, which are not necessarily drawn to scale, and wherein:

FIG. 1 is a high level diagram of a controller system, in accordance with one or more example embodiments.

FIG. 2 is a high level diagram of an actuator drive and position sensor excitation circuit, in accordance with one or more example embodiments.

FIG. 3 is a high level diagram of a positioning servo control system, in accordance with one or more example embodiments.

FIG. 4 is a high level block diagram of a system for driving a servo actuator, in accordance with one or more example embodiments.

FIG. 5 is a topology of a system for driving a servo actuator, in accordance with one or more example embodiments.

FIG. 6 is a flow diagram illustrating a method for driving a servo actuator, in accordance with one or more example embodiments.

### DETAILED DESCRIPTION

Illustrative embodiments of the disclosure will now be described more fully hereinafter with reference to the accompanying drawings, in which some but not all embodiments of the disclosure may be shown. Indeed, the disclosure may be embodied in many different forms and should not be construed as limited to the embodiments set forth herein; rather, these embodiments are provided so that this disclosure satisfies applicable legal requirements. Like numbers refer to like elements throughout.

One may appreciate that information and signals may be represented using any of a variety of different technologies and techniques. For example, data, instructions, commands, information, signals, bits, symbols, codes, and chips that may be referenced throughout the description can be represented by voltages, currents, electromagnetic waves, magnetic fields or particles, or any combination thereof.

The term “topology” as used herein refers to interconnections of circuit components and, unless stated otherwise, indicates nothing of a physical layout of the components or their physical locations relative to one another. Figures described or otherwise identified as showing a topology are no more than a graphical representation of the topology and do not necessarily describe anything regarding physical layout or relative locations of components.

Certain embodiments of the disclosure provide for a system for driving servo actuators that enables complete or partial elimination of heat sinks by replacing the linear output devices with switching amplifiers. According to example embodiments, switching devices may be provided for driving actuators associated with a turbine and for driving excitation signals for position sensors associated with actuators. According to example embodiments, the system may have improved efficiency in light of reduced heat dissipation. The reduction in heat dissipation may eliminate or enable the reduction in the size of heat sinks as compared to those in linear amplifier drivers.

In this regard, the technical effects of one or more embodiments of the disclosure may include decreasing heat dissipation from the use of heat sinks Further technical effects may optionally include decreasing the cost and/or complexity of the servo actuators circuitry. Further technical effects may optionally include decreasing physical dimensions and sizes and simplifying the design of the heat sinks Further technical effects may optionally include ensuring that switches operate even under light load conditions.

According to certain example embodiments of the disclosure, a switching output amplifier is provided for use as a servo actuator. In certain embodiments, the switching amplifier may provide average DC in the range of about ±10 mA to ±200 mA for controlling the servo actuator depending on its size and particular application. It should be understood that the actuator current may flow in two directions, thereby enabling direct and reverse rotation of the servo actuator.

According to certain example embodiments, the switching output amplifier may be used in a position sensor. In general, the position sensors may include resolvers, LVDTs, LVDR devices, rotary variable differential transformers (RVDTs), and rotary variable differential reluctance (RVDR) devices. Such devices have proven to be reliable, even in the harsh environmental conditions associated with gas and steam turbines, primarily due to electromagnetic coupling from an excitation coil to one or more sensing coils via a moveable core that may be coupled (directly or indirectly) to the actuator. It should be understood that the term LVDT may be defined to refer to any similar position detector, linear or rotary.

In accordance with certain embodiments of the disclosure, one or more actuators may be controlled by generating a reference signal. Based on this reference signal, a switched signal may be generated for manipulating the actuator. In certain example embodiments, generating the reference signal may comprise generating a PWM signal. In certain embodiments, at least a part of the switched signal coupled to the actuator may be sensed and utilized as feedback for further controlling the reference signal or the switched signal.

In certain embodiments, the position of the actuator, valve, or vane may be determined by generating a switched excitation signal and applying the excitation signal to the excitation winding of an LVDT or similar device attached or coupled to the actuator. The excitation winding may couple the switched excitation signal to a secondary (or sensing) winding on the LVDT device with the coupling strength proportional to the position of the actuator, valve, or vane position. The coupled switched excitation signal may be utilized as a second feedback for position control of the actuator via a servomechanism. According to example embodiments, the reference signal may be controlled based at least in part on feedback associated with the excitation signal.

Various system components for efficiently controlling and monitoring an actuator, vane, or valve positions, according to example embodiments, will now be described with reference to the accompanying drawings.

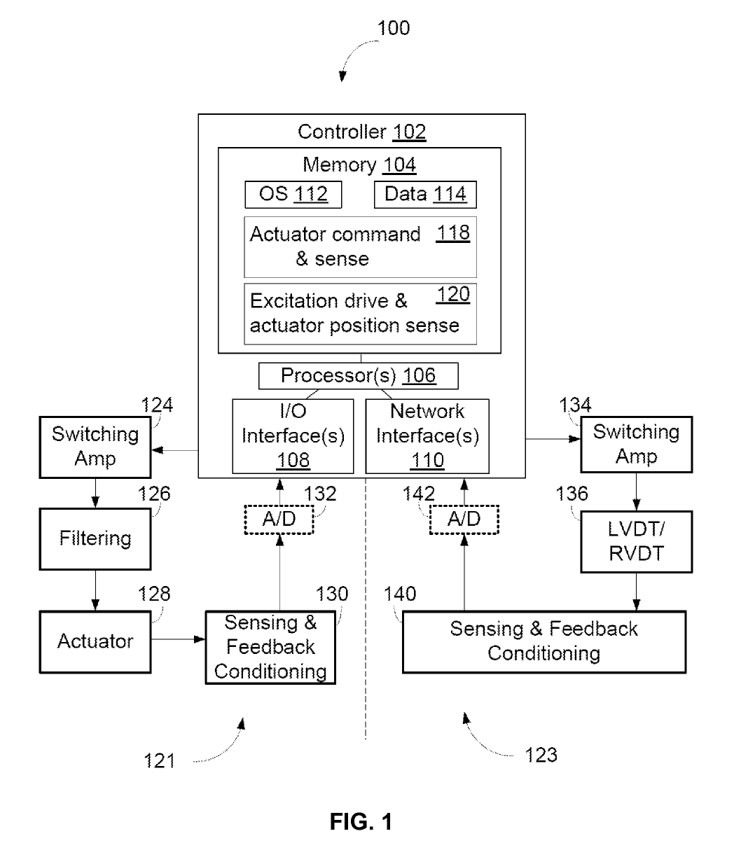

FIG. 1 illustrates a high level diagram of a controller system 100, according to example embodiments of the disclosure. The controller system 100 may include a controller 102, at least one memory 104, and one or more processors 106. According to example embodiments, the controller 102 may also include one or more input/output interfaces 108 and one or more network interfaces 110. The memory 104 associated with the controller 102 may include an operating system 112 and data 114. The memory 104 may also include one or more modules that are configured, programmed, or operable to carry out the processes associated with the controller 102. In certain example embodiments, the memory 104 may include an actuator command and sense module 118. In certain example embodiments, the memory 104 may include an excitation drive and actuator valve, or vane position sense module 120.

FIG. 1 also illustrates actuator driving and sensing circuitry 121 and excitation drive and actuator valve (or vane position sense circuitry) 123. In accordance with an example embodiment of the disclosure, the actuator driving and sensing circuitry 121 may include a switching amplifier 124, filtering components 126, an actuator 128, and sensing and feedback conditioning circuitry 130. According to an example embodiment, an analog-to-digital (A/D) converter 132 may also be included. The A/D converter may take the form of a voltage-controlled oscillator, a successive-approximation register converter, a Delta-Sigma converter, or a flash converter. In other example embodiments, the feedback may be converted to a digital signal.

Still referring to FIG. 1, the position sense circuitry 123 may include a switching amplifier 134; a position sensor 136, which may include an LVDT; and sensing and feedback conditioning circuitry 140. According to an example embodiment, an A/D converter 142 may also be included in the position sense circuitry 123. The A/D converter 142 may take the form of a voltage-controlled oscillator, a successive-approximation register converter, a Delta-Sigma converter, a flash converter, and so forth.

In accordance with example embodiments of the disclosure, the actuator 128 may control the flow of hydraulic fluid or oil for filling or emptying a cylinder. The cylinder may include a piston connected to a valve, and the valve may be controlled by the amount of hydraulic fluid in the cylinder. The position sensor 136 may include an armature that may be mechanically linked to the valve. The armature may couple an excitation signal from an excitation coil to a sensing coil based on the position of the valve.

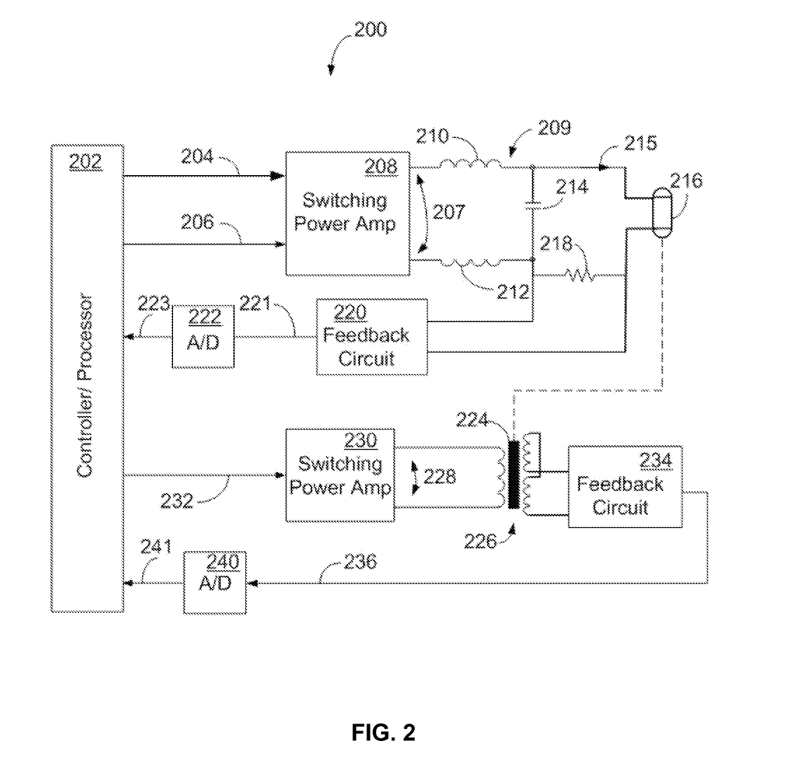

FIG. 2 shows a high level diagram of an example actuator drive and position sensor excitation circuit 200, according to an example embodiment. As shown in this figure, the circuit 200 may include a controller/processor 202. The controller/processor 202 may provide an actuator reference 204 to a switching power amplifier 208. In accordance with an example embodiment, the actuator reference 204 may be a DC command, or it may be a pulse width modulation signal that is utilized to control the switching power amplifier 208.

In certain example embodiments, the actuator 216 may be of the type that requires a bidirectional or a unidirectional current; therefore, in accordance with some embodiments, the controller/processor 202 may also provide a polarity signal 206 to the switching power amplifier 208 to control the direction of the actuator 216.

Furthermore, the switching power amplifier 208 may provide a switched drive signal 207, which may be in the form of a PWM signal as described below in greater detail. One advantage of such a drive signal is that the switching power amplifier may generate less heat because the output switching devices (for example, transistors or field effect devices) are either in an on or an off state. The operation of the device (either on or off) tends to minimize resistive-type heat generation in the device, particularly when compared with linear power amplifiers where the output devices may operate in a state of semi-conduction.

According to example embodiments of the disclosure, the switching power amplifier 208 may produce a switched drive signal 207 in which the “on duration” of the signal is proportional to commanded current, as provided by the actuator reference signal 204. The frequency of the switched drive signal 207 of the switching power amplifier 208 may be on the order of approximately 100 kHz, although the switching power amplifier 208 may switch at higher or lower frequencies as required by the switching topology. According to example embodiments, the switched drive signal 207 may be filtered by a low pass filter 209 to produce actuator current 215. In certain example embodiments, the low pass filter 209 may include one or more filter inductors 210, 212, and one or more filter capacitors 214. Other filter components may be included to keep the harmonic distortion of the actuator current to within specified tolerances. For example, the filter 209 may require a total harmonic distortion of less than about 1%, and as such, may require additional filter capacitors 214 or inductors 212.

According to an example embodiment, the actuator current 215 may be supplied to an actuator 216, and the actuator current 215 may be sensed for feedback to the controller/processor via a current sense resistor 218 or similar current sensing device. Other example current sensing devices include Hall Effect current sensors or similar technology. In an example embodiment, all or part of the actuator current 215 may pass through a sense resistor 218 and may generate a voltage drop across the resistor 218 that may be further processed by a feedback circuit 220. The feedback circuit 220 may include further filtering to remove spikes or other high frequency information that may be problematic for the rest of the circuit to interpret. The feedback circuit 220 may provide a current feedback signal 221 (also referred to as a “second feedback”) to an A/D converter 222, which may provide the digital signal 223 to the controller/processor 202.

Also shown in FIG. 2 are component block diagrams corresponding to the excitation drive and position sense circuitry 123 shown in FIG. 1. In accordance with example embodiments, the controller/processor 202 may provide an excitation reference signal 232 for controlling a switching power amplifier 230. In an example embodiment, the excitation reference signal 232 may be a sine weighted PWM signal. In other example embodiments, the excitation reference signal 232 may be an analog sine wave, depending on the configuration of the switching power amplifier 230. In accordance with an example embodiment of the disclosure, the switching power amplifier 230 may produce a switched excitation signal 228 that may be used to drive one or more excitation coils on one or more position sensors 226. The switched excitation signal 228 may be coupled to one or more sensing coils in position sensor 226, and the strength of the coupled signal may depend on the position of a moveable core 224 within the position sensor 226, which in turn may be coupled to the actuator 216.

Further, the excitation signal 228 that is transmitted through the position sensor 226 may be further processed by a feedback circuit 234 to produce an excitation signal feedback 236. According to an example embodiment, the excitation signal feedback 236 may be converted to a digital signal 241 for the controller/processor 202 by an A/D converter 240.

In certain example embodiments, the position sensor excitation circuitry, including a switching power amplifier 230, may provide an alternating current excitation signal 228 of approximately 7 volts root-mean-squared (RMS) and approximately 3.2 kilohertz in frequency. Other amplitudes and frequencies may be generated, in accordance with example embodiments of the disclosure. In certain embodiments of the disclosure, multiple position sensors 226 may utilize the same excitation signal 228 (for example, via an excitation bus), so that a single switching power amplifier 230 may provide the excitation signal 228 for multiple LVDT excitation coils, thereby improving the space and power efficiency of the circuit 200. In example embodiments, the maximum number of position sensors 226 driven by the switching power amplifier 230 may be determined based on the maximum rated power output available from the particular switching power amplifier 230 without having to install a heat sink on the circuitry for heat dissipation.

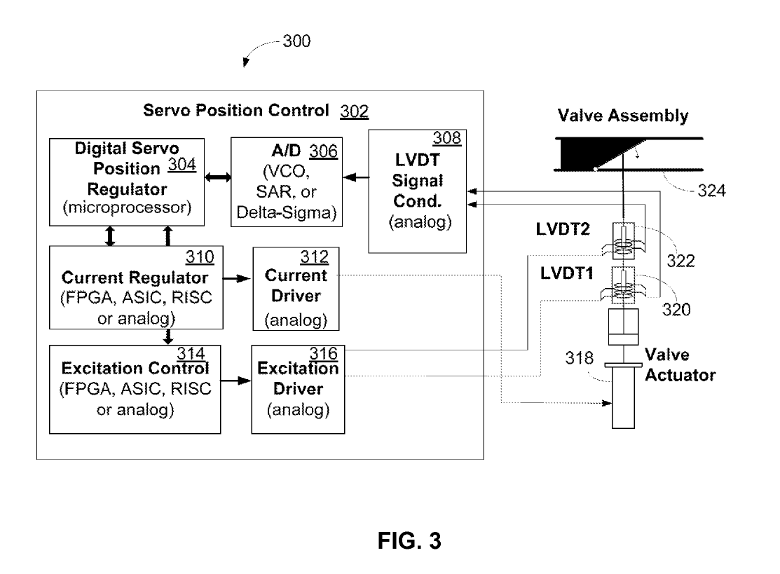

FIG. 3 shows a high level diagram of a positioning servo control system 300, according to an example embodiment. As shown in the figure, the positioning servo control system 300 may include a servo position control 302. The servo position controller 302 may include one or more of: a digital servo position regulator 304, A/D converters 306, a position sensor signal conditioning module 308, a current regulator 310, a current driver 312, an excitation control 314, and an excitation driver 316. The servo position controller 302 may provide an actuator switched drive signal for controlling an actuator 318 coupled to a valve assembly 324. The actuator 318 may also be coupled with one or more position sensors 320, 322. In accordance with an example embodiment of the disclosure, the servo position controller 302 may also provide a switched excitation drive signal for the position sensors 320, 322. In accordance with an example embodiment of the disclosure, the position sensors 320, 322 may provide position feedback to the servo position controller 302 in response to the position of the actuator 318.

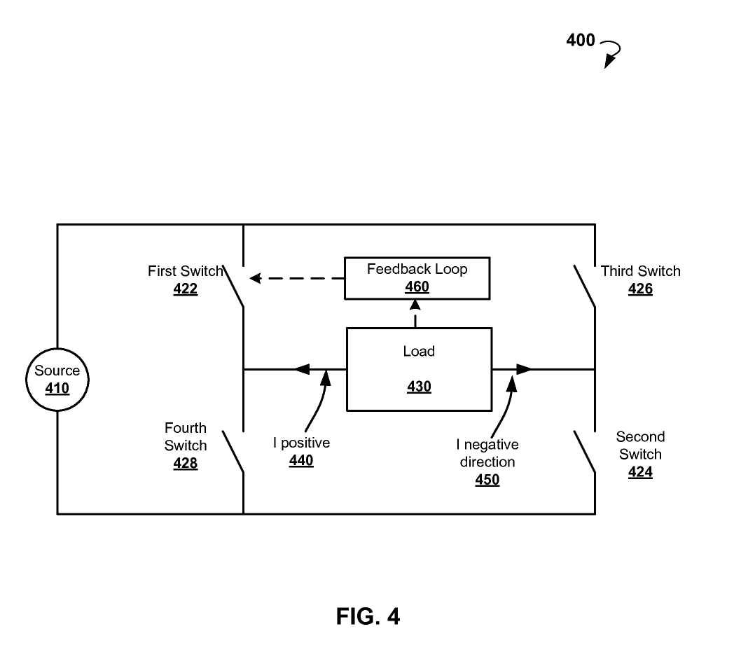

FIG. 4 shows a high level block diagram of a system 400 for driving a servo actuator, according to an example embodiment. In accordance with example embodiments, a power source 410 may be utilized to supply current through the load 430. The load 430 may include a servo actuator (which may be, for example, the actuator 216 of FIG. 2 or the actuator 318 of FIG. 3), LVDT, RVDT, or a similar device. The current supplied to the load 430 via a H-bridge control circuit. As shown in the figure, the H-bridge control circuit is defined by a first switching device 422, a second switching device 424, a third switching device 426, and a third switching device 428. According to example embodiments, the switching devices 422-428 may include MOSFETs, which may be utilized to control bi-directional current. In accordance with other example embodiments of the disclosure, other various semi-conductor and/or solid state switching devices may be utilized as the switching devices 422-428. In certain embodiments, freewheeling diodes, capacitors, inductors, and other components may be included and associated with the switching devices.

According to example embodiments, the state of each switching device 422-428 may be independently controlled by one or more switch drive signals generated by a controller such as, for example, the controller/processor 202. In certain example embodiments, the conduction state of the pairs of switching devices (422 and 424) or (426 and 428) may be utilized to control the direction of current through the load 430. It should be understood that passing bi-directional drive currents 440, 450 through the load 430 may involve manipulating and/or coordinating one or more switching devices 422-428 in order to establish at least one positive current path 440 and at least one negative current path 450 through the load 430. More specifically, when the first switching device 422 and the second switching device 424 are turned on (i.e., triggered, in the excitation, or in the closed state), while the third switching device 426 and the second switching device 428 are turned off (i.e., in the open state), the positive current path 440 is established through the load 430. Alternatively, when the first switching device 422 and the second switching device 424 are turned off, while the third switching device 426 and the second switching device 428 are turned on, the negative current path 450 is established through the load 430.

According to one or more embodiments, the system 400 may employ one or more feedback loops, such as a feedback loop 460 shown in FIG. 4 (which in turn may be at least a part of the feedback circuit 220 and/or 234 according to certain example embodiments). The feedback loop 460 may sense at least one of the currents 440, 450 associated with the load 430 and adjust or control the operation of at least the first switching device 422 so as to control the currents 440, 450 flowing through the load 430 based on the feedback. In accordance with example embodiments, the actuator currents 440, 450 may be controlled based on a comparison of the feedback of actuator currents 440, 450 and a reference signal. In an example embodiment, two mutually exclusive current paths may be bridged with the load 430. In accordance with certain example embodiments, the currents 440, 450 may be achieved by using hysteretic control as described below.

Those skilled in the art will understand that although just one feedback loop 460 is shown in FIG. 4, there may be provided additional feedback loops associated with the load 430 and remaining switching devices 424-248. For example, one feedback loop 460 may be provided to control the positive current 440 by controlling/adjusting the operation of the first switch 422, and another feedback loop (not shown) may be provided to control the negative current 450 by controlling/adjusting the operation of the third switch 426.

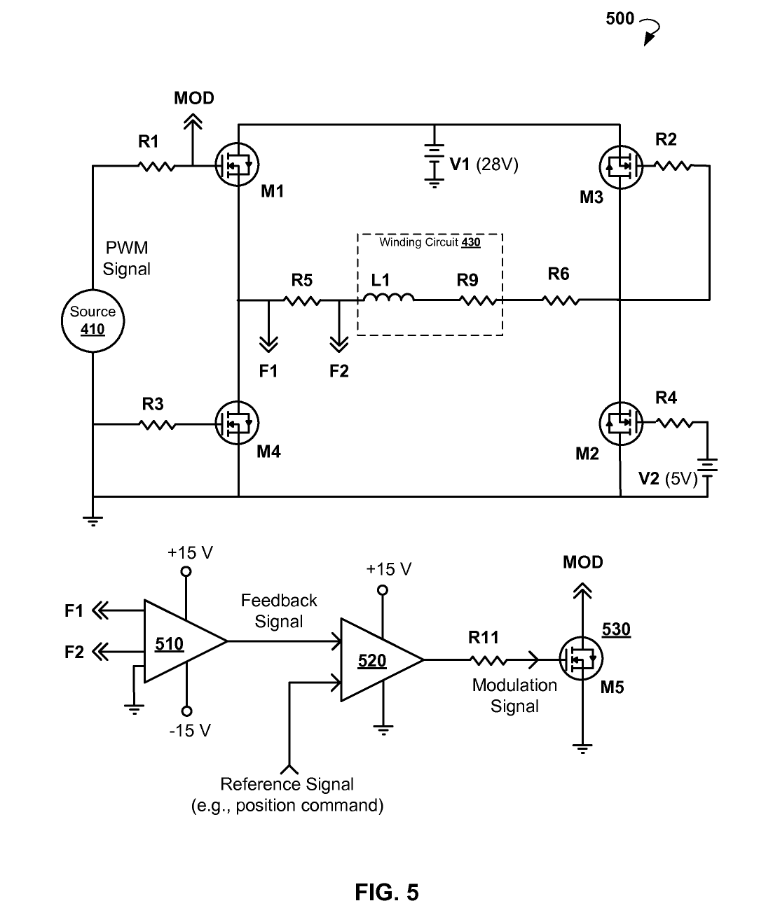

FIG. 5 shows an example topology of a system 500 for driving a servo actuator, according to an example embodiment. In general, the system 500 is a particular example of the system 400 shown in FIG. 4. The system 500 serves for driving a load such as, for example, a servo actuator 216 of FIG. 2, the actuator 318 of FIG. 3, LVDT, RVDT, or the like. As depicted in the figure, the system 500 includes a clock source 505 operatively coupled with a H-bridge control circuit, which in turn is represented by switching devices M1, M2, M3, M4 (422-426) and at least one winding circuit 430 of the load. The winding circuit 430 (e.g., of a servo actuator) may be represented by an inductive element L1 and a resistor R9.

As discussed above, the switching devices M1-M4 (422-428) may include MOSFETs, or any other suitable switching or relaying devices. In the example embodiment shown in FIG. 5, the switching device M2 (424) is involuntary forced into the closed state (i.e., turned on), while the switching devices M3, M4 (426, 428) are involuntary forced into the open state (i.e., turned off). The system 500 includes a feedback loop 460 that controls the operation of the switching device M1 (422) thereby controlling the currents flowing through the at least winding of the load 430. Accordingly, for mere illustrative purposes, operation of the system 500 is given for the case when the current 440 flows in only one direction. A similar system can be developed to generate current 450, flowing in in the opposite direction, and this system may have similar topology, but it is not detailed here so as not to burden the disclosure of selected embodiments.

Still referring to FIG. 5, resistors R5 and R6 placed in series with the winding circuit 430 may be used for sensing the actual current through the load represented by the winding circuit 430. For positive direction of the current 440 (i.e., when the switching devices M1 and M2 (422 and 424) are in the closed state), voltage across resistor R5 is measured and used as a current feedback signal in the feedback loop 460. The switching device M1 (422) may be driven by a high frequency clock signal of suitable amplitude generated by a controller (not shown), such as the controller/processor 202, which may be fed to the H-bridge circuit by the clock source 505. The clock signal, which may in certain instances be referred to as a PWM signal, from the clock source 505 switches the first switching device M1 (424) causing high frequency current to flow through the winding circuit 430. The winding current may be measured utilizing the resistors R5 or R6 as shown in FIG. 5. Specifically, a potential drop sensed by a differential amplifier 510 may indicate a flow of current through the resistor R5. The differential amplifier 510 amplifies the difference between the two sensed voltages and generates a feedback signal that is then fed to a differential comparator 520. The differential comparator 520 may then compare the feedback signal with a predetermined reference signal. In an example, the feedback signal may be compared to a position command generated by the controller. In turn, the position command may determine the magnitude of current flowing through the winding circuit 430.

Based on the comparison of the feedback signal and the predetermined reference signal, the differential comparator 520 generates a corresponding modulation signal and supplies it to a gate of a modulation switching device M5 (530), which is a MOSFET device in this example. In other words, when the feedback signal exceeds the predetermined reference signal, the differential comparator 520 may change its output state from the ‘LOW’ level to the ‘HI’ level, which thereby turns the modulation switching device M5 (530) into the open state (i.e., turned off). Further, the modulation switching device M5 (530), which is operatively connected to the gate of the first switching device M1 (422), grounds the clock signal from the clock source 505 to the gate of first switching device M1 (422), and the first switching device M1 (422) shuts down such that the current through the winding circuit 430 starts to decrease.

When the feedback signal is below the predetermined reference signal (e.g., the position command), the differential comparator 520 changes state from the ‘HI’ level to a ‘LO’ level, thereby turning the modulation switching device M5 (530) off (i.e., the switch M5 is forced into the open state). In this case, the gate of the first switching device M1 (422) is restored, and the first switching device M1 (422) starts switching, driving current through the winding circuit 430 and increasing the load current. This cycle repeats and the current through the load is maintained at the value defined by the position command.

According to one or more embodiments, the constant high frequency clock signal supplied to the first switching device M1 (422) ensures that it is either in cut-off or in saturation and never in linear region. The high frequency of the clock produces a ripple current that may have a high enough frequency at light loads so that the load (e.g., servo actuator) cannot respond to it. The high frequency clock may also ensure that the resolution requirements for a particular application are also met. It should be also noted that the system 500 provides a finite delay time when the feedback signal is compared with the predetermined reference signal.

The above described circuit thereby enables a hybrid of PWM, PFM, and hysteresis control of the load. More specifically, the PWM is ensured by the use of power source 410, which generates an adaptive clock signal. The hysteresis control is ensured by the fact that a frequency of PWM signal supplied to the first switching device M1 (422) is not constant and, instead, changes dynamically based on the current flowing through the winding circuit 430. The PFM is ensured by the operation of the modulation switching device M5 (530), which provides an adaptive delay in the triggering of the first switching device M1 (422). Accordingly, this hybrid PWM, PFM, and hysteresis control operation eliminates the drawbacks of prior art systems. In other words, the system 500 generates a switching control signal for the switching device M1 (422) that gives high resolution and produces frequency ripple that is high enough to ensure that the servo actuator does not respond to it, regardless of load condition.

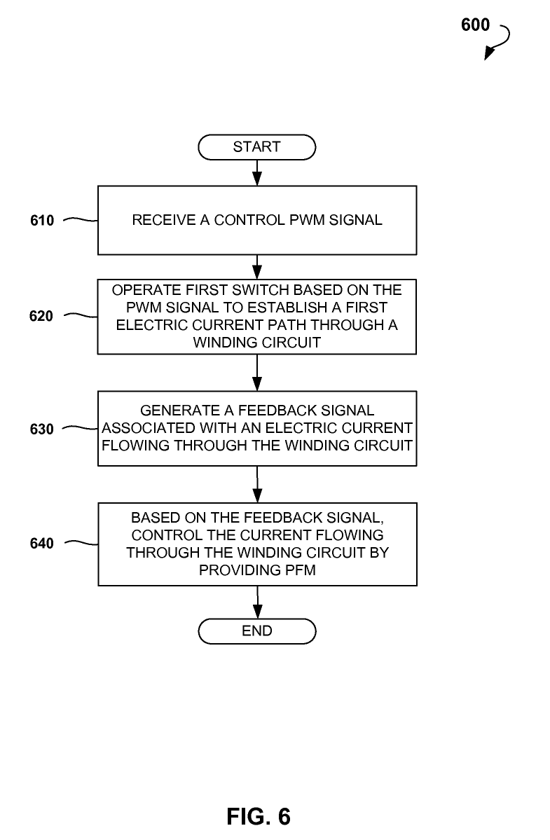

FIG. 6 shows an example flow diagram illustrating a method 600 for driving a servo actuator, according to one or more embodiments of the disclosure. The method 600 may be implemented by the systems 100, 200, 300, 400, and 500 as described herein with reference to FIGS. 1-5.

The method 600 may commence in operation 610 with the first switching device M1 (or alternatively with the third switching device M3, depending on an application) receiving a control PWM signal from the power source 410. The control PWM signal is provided to the gate of the first switching device M1 forcing it to periodically turn into open states and close states. Accordingly, at operation 620, the control PWM signal operates the first switching device M1 so as to establish a current path through at least one winding circuit 430 of load (e.g., a servo actuator).

At operation 630, the feedback loop 460 generates a feedback signal associated with the current path of the at least one winding circuit 430 of load. In particular, the feedback signal may represent an amplified difference of voltages sensed on the resistor R5 of FIG. 5. At operation 640, the feedback loop 460 controls the current flowing through the at least one winding circuit 430 of load by providing PFM. As described above, the PFM is based on the feedback signal dynamically compared to a predetermined reference value so as to adjust the operation of the first switching device M1 by electrically connecting its gate to the ground with the help of the modulation switching device M5. Thus, the method 600 provides a topology of system 500 governed by a hybrid of PFM-PWM and hysteretic controls.

Thus, example systems and methods for driving servo actuators, LVDTs, and similar devices have been described. Although the embodiments have been described with reference to specific example embodiments, it will be evident that various modifications and changes can be made to these example embodiments without departing from the broader scope of the application. Accordingly, the specification and drawings are to be regarded in an illustrative rather than a restrictive sense.

What is claimed is:

1. A method for driving a servo actuator, the method comprising:
receiving a control pulse width modulation (PWM) signal;
operating a first switch based at least in part on the control PWM signal to establish an electric current path through a winding circuit of the servo actuator;
generating a feedback signal based at least in part on one electric current flowing through the winding circuit; and
controlling the electric current flowing through the winding circuit by providing a pulse frequency modulation (PFM) of the first switch based on the feedback signal.

2. The method of claim 1, further comprising providing a H-bridge control circuit, wherein the H-bridge control circuit comprises the first switch and windings of the servo actuator.

3. The method of claim 2, wherein the H-bridge control circuit further comprises a second switch, the first switch and the second switch being opposite switches constituting a half bridge control circuit with the second switch closed.

4. The method of claim 1, wherein the providing of feedback comprises measuring one or more voltages associated with the electric current flowing through the winding circuit.

5. The method of claim 4, wherein the generating of the feedback signal comprises amplifying a difference in the one or more voltages associated with the electric current flowing through the winding circuit.

6. The method of claim 5, further comprising generating a modulation signal based on a comparison of the feedback signal and a reference signal.

7. The method of claim 6, further comprising operating a modulation switch based on the modulation signal.

8. The method of claim 7, wherein the operating of the modulation switch provides the PFM of the first switch.

9. The method of claim 7, further comprising:
determining that the modulation signal exceeds the reference signal; and
based on the determination, closing the modulation switch.

10. The method of claim 9, further comprising opening the first switch based at least in part on the closing of the modulation switch.

11. The method of claim 7, wherein the modulation switch and the first switch provide a hysteretic control over the electric current flowing through the winding circuit.

11. A system for driving a servo actuator, the system comprising:
a H-bridge control circuit configured to be coupled to a winding circuit of the servo actuator, wherein the H-bridge control circuit comprises a first switch;
a controller configured to provide a first pulse width modulation (PWM) signal to the first switch, wherein the first PWM signal drives the first switch to periodically establish a first one-direction electric current path through the winding circuit;
a feedback loop configured to detect an electric current flowing through the winding circuit and, based at least in part on the detection, generate a pulse frequency modulation (PFM) signal; and
a first modulation switch configured to force the first switch to periodically open based at least in part on the PFM signal controlling the electric current flowing through the winding circuit.

12. The system of claim 11, wherein the servo actuator comprises one or more of a servo actuator, a linear variable differential transformer, and a rotary variable differential transformer.

13. The system of claim 11, wherein the first switch and the first modulation switch comprise one or more of metal-oxide-semiconductor field-effect transistors (MOSFETs).

14. The system of claim 11, wherein the H-bridge control circuit further comprises a second switch, the first switch and the second switch being opposite switches constituting a half bridge control circuit which, when enabled, causes the electric current to flow through the winding circuit in one direction.

15. The system of claim 14, wherein the second switch is permanently closed.

16. The system of claim 11, wherein the feedback loop comprises at least one differential comparator configured to generate the PFM signal based on a comparison of the electric current flowing through the winding circuit to a reference value.

17. The system of claim 11, wherein the feedback loop is further configured to delay closing times and opening times of the first switch to provide hysteretic control over the electric current flowing through the winding circuit.

18. The system of claim 11, wherein the H-bridge control circuit further comprises a third switch and the controller is further configured to provide a second PWM signal to the third switch to periodically establish a second one-direction electric current path through the winding circuit, with the second one-direction electric current path being opposite to the first second one-direction electric current path.

19. The system of claim 18, further comprising a second modulation switch configured to force the third switch to periodically open based at least in part on the PFM signal of the feedback loop controlling the electric current flowing through the winding circuit.

20. A system for driving a servo actuator, the system comprising:
a winding circuit associated with the servo actuator;
a H-bridge control circuit operationally coupled to the winding circuit, wherein the H-bridge control circuit comprises a first switch, a second switch, a third switch, and a forth switch;
a controller configured to provide a pulse width modulation (PWM) signal to the first switch, wherein the first PWM signal drives the first switch such that a first one-direction electric current path through the winding circuit is periodically established with the third switch and the fourth switch in an open state while the second switch in a closed state;
an internal feedback loop configured to detect an electric current flowing through the winding circuit by measuring a voltage difference with a detection resistor; and
wherein the internal feedback loop is further configured to generate a pulse frequency modulation (PFM) signal based at least in part on a comparison of the voltage difference to a reference voltage; and
a first modulation switch configured to force the first switch to periodically open based at least in part on the PFM signal controlling the electric current flowing through the winding circuit.
